(19) United States
(12) Patent Application Publication
(10) Pub. No.: US 2025/0380720 A1
(43) Pub. Date: Dec. 18, 2025

(54) PROCESS FOR PREPARING A PLANT-BASED FOOD DOUGH

(71) Applicant: AAK AB (PUBL), Malmö (SE)

(72) Inventors: Lidiya KARDAMOVA, Malmö (SE); Margarete Rosa KERFERS, Malmö (SE); Lucas HARDY, Malmö (SE)

(21) Appl. No.: 18/878,194

(22) PCT Filed: Jun. 26, 2023
(86) PCT No.: PCT/SE2023/050660

§ 371 Date: Dec. 23, 2024

(30) Foreign Application Priority Data
Jun. 24, 2022 (SE) 2230209-5
Mar. 9, 2023 (SE) 2330118-7

(51) Int. Cl. A23J 3/26; A23D 9/00; A23J 3/16; A23J 3/22

(52) U.S. Cl. CPC A23J 3/26; A23D 9/00; A23J 3/16; A23J 3/227

(57) ABSTRACT

Disclosed herein is a process for preparing a plant-based food dough using an extruder, said extruder comprising an extruder barrel and a cooling die, the process comprising the steps of: A) feeding the extruder barrel with less than 35% by weight of non-animal protein relative to the total weight of the plant-based food dough; B) feeding the extruder barrel with from 35 to 80% by weight of water relative to the total weight of the plant-based food dough; C) feeding the extruder barrel with less than 45% by weight of a starch relative to the total weight of the plant-based food dough; D) feeding the extruder barrel with from 1 to 30% by weight of a melted fat composition relative to the total weight of the plant-based food dough so as to form a plant-based food mixture; E) extruding the plant-based food mixture through the cooling die.

### FIELD OF THE INVENTION

The invention relates to a process for preparing a plant-based food dough, a plant-based food product and the use of said plant-based food doughs and/or products. In particular, the invention relates to the use of certain fat compositions in said process for preparing plant-based food doughs and plant-based food products to improve their properties.

### BACKGROUND OF THE INVENTION

There is an increasing demand for plant-based foods due to consumers increasing desire to eat healthy, sustainably sourced food products and to generally lower their meat and dairy intake. There is also an increasing number of vegans who require food products to be completely absent of animal-derived products for ethical and health reasons. This has led to the development of various plant-based food products such as plant-based meats (meat analogue compositions) and plant-based cheeses (cheese analogue compositions) which aim to mimic certain qualities of the animal-derived meat and cheese products, such as the texture, taste and/or appearance.

Many different types of meat-analogues are available which aim to mimic the organoleptic properties of meat. A particular property of some meat, such as chicken muscle or certain fish filets, is the presence of animal fat dispersed into the meat and/or a fibrous texture. In order to effectively mimic this property in a meat-analogue or cheese analogue, it is known to use processes to form texturized plant-based food products such as high-moisture extrusion processes.

High-moisture extrusion processes are a known technology for texturizing vegetable protein to produce plant-based products having a fibrous animal meat-like texture or similar to certain types of cheese. In practice, where the ingredients consist of protein and water, the formed extrudate is usually dark in colour, is too hard, too dense, too dry and is too chewy when compared to meat, such as chicken muscle or certain fish filets. It is known to further add liquid oil or solid fat. Nevertheless, plant based extrudates do not completely mimic the texture, appearance and/or the taste of real animal-based products. As a result, consumers typically consider such plant-based food products to be unattractive and inedible.

The documents discussed below disclose processes for forming certain plant-based food products. However, these processes do not address and/or alleviate many of the problems discussed above associated.

WO2016150834 discloses a process for preparing a meat-analogue food product, the process comprising the steps of:
a) feeding an extruder barrel with 40-70 wt % water and 15-35 wt % plant protein;
b) injecting 2-15 wt % liquid oil, fat or a combination thereof into the extruder barrel at a location downstream of the feeding location of step a);
c) Extruding the mixture through a cooling die.

WO2012051428 discloses a meat analogue composition comprising a structured plant protein product, wherein the structured plant protein product comprises protein fibers that are substantially aligned, wherein the protein fibers comprise:
(a) dry ingredients that comprise:
(i) a protein component that comprises a plant-derived protein material, wherein the protein component is at an amount that is no more than about 90% by weight of the dry ingredients;
(ii) a carbohydrate component at an amount that is in the range of about 2 to about 50% by weight of the dry ingredients; and
(iii) a lipid component at an amount that is in the range of about 0.1 to about 5% by weight of the dry ingredients; and
(b) wet ingredients that comprise water; and
wherein the structured plant protein product has a moisture content that is at least about 50% by weight of the structured plant protein product. The edible lipid component may be liquid oil.

There remains a need for providing a process of preparing plant-based food products that solve or alleviate many of the problems discussed above such as to mimic cheese or meat. There is also a need for a process of preparing plant-based food products having the appearance and texture of food products such as animal meat or cheese. In particular, there is a need to produce plant-based food products having an improved fibrosity, chewiness and hardness when compared to conventional plant-based food. There is also a need for a process of preparing plant-based food products having improved sensory requirements such as juiciness and mouthfeel.

### SUMMARY OF THE INVENTION

According to a first aspect of the invention, there is provided a process for preparing a plant-based food dough using an extruder, said extruder comprising an extruder barrel and a cooling die, the process comprising the steps of:
A). feeding the extruder barrel with less than 35 wt % by weight of non-animal protein relative to the total weight of the plant-based food dough;
B). feeding the extruder barrel with from 35 to 80 wt % by weight of water relative to the total weight of the plant-based food dough,
C). feeding the extruder barrel with less than 45% by weight of a starch relative to the total weight of the plant-based food dough;
D). feeding the extruder barrel with from 1 to 30 wt % by weight of a melted fat composition so as to form a plant-based food mixture;
E). extruding the plant-based food mixture obtained in step D) through the cooling die so as to form a plant-based food dough.

The present invention is based upon the surprising finding that using melted fat compositions solve or alleviate many of the problems discussed above associated with the use of liquid oil, solid fat or no use of any oil in a high moisture extrusion process. It has been found that the use of melted fat compositions in the above process provides plant-based food products that mimic cheese or meat present in animal products. Without willing to be bound by any theory, it is believed that the melted fat forms a matrix when said melted fat is mixed with the other ingredients. Indeed, the other ingredients collaborate with the melted fat to obtain a specific chemical and physical organization providing a plant-based food dough with properties closer resembling meat or cheese. The fat composition in its melted state has the optimal properties to bind all the other ingredients so that the texture and appearance of the plant-based food dough is improved compared to plant-based products produced by conventional high moisture extrusion process using liquid oil, solid fat or not using of any oil. In particular, it has been found that plant-based food products obtained by the above process using a melted fat leads to an improved fibrosity, chewiness and hardness when compared to conventional plant-based food products obtained by a high moisture extrusion process using liquid oil, solid fat or not using any oil. Furthermore, the above process provides plant-based food products having improved sensory requirements such as juiciness and mouthfeel. Additionally, the inventors have found that using a melted fat improves the processability when compared to using a liquid oil. Indeed, when using a melted fat, the pressure in the extruder remains stable.

The term “fat” as used herein refers to glyceride fats and oils containing fatty acid acyl groups and does not imply any particular melting point. The term “oil” is used synonymously with “fat” herein.

The term “melted state” is the state obtained after melting a substance from a semi-solid or solid state to a liquid state, i.e. a state wherein the solid fat content (SFC) according to ISO 8292-1 is below 1%.

The term “melted fat composition” as used herein is thus used to refer to a fat composition that is a solid or semi-solid at 20° C.; and that has been heated to above 20° C. so as to have a solid fat content of less than 1% as determined by ISO 8292-1. Preferably, the term “melted fat composition” as used herein is used to refer to a fat composition that is a solid at 20° C., and that has been heated to above 20° C. so as to have a solid fat content of less than 1% as determined by ISO 8292-1.

The term “melted fat composition” is not used to refer to a liquid oil that is liquid at room temperature (e.g. 20° C.) and that does not require heating to above this temperature in order to be a liquid. Such oils include sunflower oil and rapeseed oil.

The term “fatty acid”, as used herein, refers to straight chain saturated or unsaturated (including mono- and poly unsaturated) carboxylic acids having 8 to 24 carbon atoms. A fatty acid having x carbon atoms and y double bonds may be denoted Cx:y. For example, palmitic acid may denoted C16:0, oleic acid may denoted C18:1. Percentages of fatty acids in compositions referred to herein include acyl groups in tri-, di- and mono-glycerides present in the glycerides and are based on the total weight of C8 to C24 fatty acids. The fatty acid profile (i.e. composition) may be determined, for example, by fatty acid methyl ester analysis (FAME) using gas chromatography according to ISO 12966-2 and ISO 12966.4.

Triglyceride content may be determined for example based on molecular weight differences (Carbon Number (CN)) by AOCS Ce 5-86. The notation triglyceride CNxx denotes triglycerides having xx carbon atoms in the fatty acyl groups, e.g. CN54 includes tristearin. Amounts of triglycerides specified with each carbon number (CN) as is customary terminology in the art are percentages by weight based on total triglycerides of CN26 to CN62 present in the fat composition.

In one or more embodiments, in step D), the amount of the melted fat composition is from 1% to 15% by weight relative to the total weight of the plant-based food dough, preferably from 1 to 10% by weight, more preferably from 1 to 8% by weight, and advantageously from 1 to 4% by weight. In this embodiment, it is believed that the fibrosity, the chewiness and the hardness of the plant-based dough is further improved.

In one or more embodiments, in step D), the amount of the melted fat composition is from 15 to 30% by weight relative to the total weight of the plant-based food dough, preferably from 20 to 30% by weight.

In one or more embodiments, in step D), the melted fat composition comprises from 20% to 85% by weight of saturated fatty acid residues; from 2% to 50% by weight of stearic acid residues (C18:0); and from 1% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition. It has been found that these fat compositions have an improved nutritional profile relative to fats, such as coconut fat, due to having lower amounts of saturated fatty acid residues. Surprisingly, these melted fat compositions improve various properties of plant-based food doughs such as various sensory properties of the compositions, such as juiciness, when cooked or partially cooked, in comparison to plant-based food doughs made using liquid oils or rapeseed oil, solid fats or not using any oil. The fat compositions thus improve both the nutritional value and sensory properties of the finished plant-based food products.

Typically, in step D), the melted fat composition comprises from 20% to 70% by weight of saturated fatty acids. Preferably, in step D), the melted fat composition comprises from 20% to 65% by weight of saturated fatty acids, more preferably from 20% to 60% by weight of saturated fatty acids; and most preferably from 30% to 50% by weight of saturated fatty acids. In other embodiments, in step D), the melted fat composition comprises from 65% to 85% by weight of saturated fatty acids. The amount of saturated fatty acid residues presents in the fat composition may be tailored so as to provide the specific desired properties of the fat composition.

In one or more embodiments, in step D), the melted fat composition comprises less than 10% by weight of palm oil, preferably, wherein the composition comprises less than 5% by weight of palm oil, more preferably, wherein the composition comprises less than 2% by weight of palm oil, and most preferably wherein the composition does not comprise palm oil.

In one or more embodiments, in step D), the melted fat composition is a non-hydrogenated fat composition.

The melted fat composition preferably comprises a greater amount of stearic acid than palmitic acid. This is advantageous from a nutritional perspective since stearic acid has a neutral effect upon total cholesterol and LDL cholesterol levels, whereas palmitic acid is known to increase total cholesterol and LDL cholesterol levels.

Typically, the melted fat composition comprises 35% by weight or less, preferably 30% by weight or less, more preferably 20% by weight or less, and most preferably 10% by weight or less of palmitic acid (C16:0). Typically, the melted fat composition has a weight ratio of stearic acid (C18:0) to palmitic acid (C16:0) of from 1:1 to 12:1 and preferably from 1:1 to 1:10.

Typically, the melted fat composition has a weight ratio of lauric acid (C12:0) to stearic acid (C18:0) of from 1:4 to 4:1. Alternatively, the melted fat composition has a weight ratio of lauric acid (C12:0) to stearic acid (C18:0) of from 4:1 to 8:1.

Typically, the melted fat composition comprises from 1% to 35% by weight of lauric acid (C12:0), and preferably from 1% to 25% by weight of lauric acid (C12:0). For example, the melted fat composition can comprise from 1% to 10% by weight of lauric acid (C12:0), from 10% to 25% by weight of lauric acid (C12:0) or from 25% to 35% by weight of lauric acid (C12:0).

Typically, the melted fat composition comprises from 2% to 45% by weight of stearic acid (C18:0) such as from 2% to 15% by weight of stearic acid (C18:0) or from 15% to 45% by weight of stearic acid (C18:0).

In some embodiments, the fat composition comprises from 1% to 25% by weight of lauric acid (C12:0); and/or from 2% to 10% by weight of stearic acid (C18:0).

Preferably, the melted fat composition comprises from 1% to 10% by weight of lauric acid (C12:0), from 10% to 25% by weight lauric acid (C12:0), or from 25% to 35% by weight of lauric acid (C12:0); and/or from 2% to 15% by weight stearic acid (C18:0), or from 15% to 45% by weight stearic acid (C18:0). More preferably, the melted fat composition comprises from 10% to 25% by weight lauric acid (C12:0); and from 15% to 45% by weight stearic acid (C18:0). Alternatively, the melted fat composition comprises from 1% to 25% by weight of lauric acid (C12:0); and/or from 2% to 10% by weight of stearic acid (C18:0).

Preferably, the melted fat composition comprises less than 25% by weight of myristic acid (C14:0), more preferably, the composition comprises less than 20% by weight of myristic acid (C14:0), more preferably less than 15% by weight of myristic acid (C14:0), or the composition does not comprise myristic acid.

Preferably, in step D), the melted fat composition comprises at least one fat selected from shea butter, shea stearin, shea olein, cocoa butter, cocoa stearin, cocoa olein, allanblackia fat, kokum fat, mango kernel fat, sal fat, illipe butter, coconut oil, coconut oil stearin, coconut oil olein, palm kernel oil, palm kernel olein, palm olein, rapeseed oil, palm oil, palm kernel stearin, babassu oil, any fraction thereof and mixtures thereof.

In some embodiments, in step D), the melted fat composition comprises a blend of coconut oil and rapeseed oil. Preferably, in these embodiments, in step D), the melted fat composition comprises a blend of from 20% to 80% by weight of coconut oil and from 20% to 80% by weight of rapeseed oil.

Preferably, the melted fat composition comprises an interesterified fat, and more preferably the fat composition comprises an interesterified fat blend. The interesterified fat or interesterified fat blend may be produced by chemical interesterification, enzymatic interesterification, or a combination thereof.

In some embodiments, the interesterified fat or interesterified fat blend is produced by an enzymatic interesterification reaction which does not reach an equilibrium product distribution. It has been found that these embodiments provide a fat composition product with optimum properties for use in a meat analogue composition, such as the properties discussed above.

Processes for the preparation of the fat compositions such as the interesterification reactions discussed above are known in the art, and are discussed in, for example, Dijkstra, A. J. Interesterification. In: The Lipids Handbook 3rd Edition, pages 285-300 (F. D. Gunstone, J. L. Harwood, and A. J. Dijkstra (eds.), Taylor & Francis Group LLC, Boca Raton, FL) (2007).

Preferably, the melted fat composition comprises an interesterified fat blend comprising a vegetable oil high in stearic acid and a vegetable oil high in lauric acid. Preferably, the vegetable oil high in stearic acid is also high in monounsaturated fatty acids such as oleic acids. Accordingly, in typical embodiments, in step D), the melted fat composition comprises an interesterified fat blend comprising at least one fat selected from shea butter, shea stearin, shea olein, cocoa butter, cocoa stearin, cocoa olein, allanblackia fat, kokum fat, mango kernel fat, sal fat, illipe butter, and mixtures thereof; and at least one oil selected from coconut oil, coconut oil stearin, coconut oil olein, palm kernel oil, palm kernel olein, palm kernel stearin, babassu oil, and mixtures thereof.

Preferably, in step D), the melted fat composition comprises an interesterified blend of shea butter and coconut oil or an interesterified blend of shea stearin and coconut oil. For example, in step D), the melted fat composition comprises an interesterified blend of from 20% to 80% by weight of shea butter and from 20% to 80% by weight of coconut oil. In one or more embodiments, in step D), the melted fat composition comprises an interesterified blend of from 20% to 80% by weight of shea stearin and from 20% to 80% by weight of coconut oil. Typically, in these embodiments, the fat composition comprises from 2 to 12 percent by weight of St2M triglycerides, preferably from 5 to 12 percent by weight of St2M triglycerides. A St2M triglyceride is a triglyceride molecule comprising two stearic acid residues and one residue of either lauric acid or myristic acid. Without being limited by theory, it has been found that fat compositions comprising St2M triglycerides in the amounts specified above aids in providing both the plasticized fat structure effect and the solid brittle structure marbling effect described above. The St2M triglycerides crystallise fast and bind oil well which aids in the provision of the effects discussed above.

Typically, the fat composition comprises from 5 to 35 percent by weight of CN46 and CN48 triglycerides, preferably from 10 to 30 percent by weight of CN46 and CN48 triglycerides. The abbreviation CN stands for the total carbon number of the fatty acid moieties present in the triglyceride molecule. For example, a triglyceride comprising two stearic acid residues and one lauric acid residue would have a total carbon number of 48.

In highly preferable embodiments, in step D), the melted fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of sunflower oil. In other preferable embodiments, the melted fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of rapeseed oil.

In one or more embodiments, in step D), the melted fat composition comprises from 2 to 12 percent by weight of St2M triglycerides, preferably from 5 to 12 percent by weight of St2M triglycerides.

A St2M triglyceride is a triglyceride molecule comprising two stearic acid residues and one residue of either lauric acid or myristic acid. Without being limited by theory, it has been found that fat compositions comprising St2M triglycerides in the amounts specified above aids in providing both the plasticized fat structure effect and the solid brittle structure marbling effect described above. The St2M triglycerides crystallise fast and bind oil well which aids in the provision of the effects discussed above.

In one or more embodiments, in step D), the melted fat composition has a melting temperature above 30° C., preferably above 35° C., such as from 30 to 60° C., such as from 40° C. to 50° C.

In other embodiments, in step D), the melted fat composition comprises an interesterified blend of palm olein and palm kernel oil. Preferably, in these embodiments, the melted fat composition comprises an interesterified blend of from 25% to 75% by weight of palm olein and from 25% to 75% by weight of palm kernel oil.

In other embodiments, in step D), the melted fat composition comprises a blend of interesterified palm olein IV 56 and palm olein IV 62-64. More preferably, the melted fat composition comprises of from 20% to 80% by weight of interesterified palm olein IV 56 and from 20% to 80% by weight of palm olein IV 62-64.

Preferably in step D), the melted fat composition has one or more of the following properties:
i). the melted fat composition has a solid fat content (SFC) N40 of less than 10, measured on unstabilised fat according to ISO 8292-1, preferably (i) from 1 to 9, and more preferably from 2 to 8, or (ii) of less than 5, more preferably of less than 3, advantageously of from 0 to 2;
ii). the melted fat composition has a solid fat content (SFC) N20 of from 35 to 60, preferably from 25 to 56, more preferably from 20 to 40, as measured on the unstabilised fat according to ISO 8292-1; or the melted fat composition has a solid fat content (SFC) N20 of from 2 to 25, preferably from 3 to 20, as measured on the unstabilised fat according to ISO 8292-1; and/or
iii). the melted fat composition has a solid fat content (SFC) N30 of from less than 36, such as from 0, or from 5 to 35, preferably from 8 to 32; more preferably from 8 to 30, as measured on the unstabilised fat according to ISO 8292-1.

Preferably, the melted fat composition has all three of the above properties.

In one or more embodiments, the melted fat composition has a solid fat content (SFC) N35 of less than 5, measured on unstabilised fat according to ISO 8292-1, preferably 4 or less; more preferably 3 or less; and most preferably 2 or less.

Preferably, prior to step D), a fat composition is heated so as to melt and form the melted fat composition in a melted state; preferably, wherein the fat composition is solid prior to melting.

Reference to ‘water’ herein is intended to include drinking water, demineralized water or distilled water, unless specifically indicated. Preferably, the water employed in connection with the present invention is demineralised or distilled water. As the skilled person will appreciate, deionized water is also a sub-class of demineralized water.

In one or more embodiments, in step A), the amount of non-animal protein is from 15 to 35% by weight relative to the total weight of the plant-based food dough, and preferably from 15 to 30% by weight.

In highly preferable embodiments, in step A), the amount of non-animal protein is from 0 to 15% by weight relative to the total weight of the plant-based food dough, preferably from 0 to 12.5% by weight, more preferably from 2 to 12% by weight, and advantageously from 3 to 12% by weight.

In one or more embodiments, in step A), the non-animal protein comprises plant protein such as algae protein, black bean protein, canola wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof; or wherein the non-animal protein comprises seitan, mushroom protein, legume protein, tempeh, yam flour, tofu, mycoprotein, peanut flour, yuba, nuts, protein derived from nuts, nut derived milk products, or a combination thereof.

More preferably, in step A), the non-animal protein comprises texturized vegetable proteins, preferably wherein the texturized vegetable proteins comprise texturized pea proteins, texturized fava proteins, or a combination thereof.

Preferably, in step A), the non-animal protein is fed to the extruder barrel in the form of a dry powder.

In one or more embodiments, in step B), the amount of water is from 40 to 80 wt % by weight relative to the total weight of the plant-based food dough, preferably from 50 to 80 wt % by weight, more preferably from 55 to 75 wt % by weight and advantageously from 60 to 75 wt % by weight. For example, in step B), the amount of water is from 35 to 55% by weight relative to the total weight of the plant-based food dough, preferably from 45 to 55% by weight or from 50 to 65% by weight.

In one or more embodiments, in step C), the amount of starch is from 0% to 45% by weight of a starch relative to the total weight of the plant-based food dough, preferably from 1 to 45% by weight, more preferably from 5% to 45% by weight, and advantageously from 20% to 30% by weight.

In one or more embodiments, in step C), the starch comprises non-modified starch, modified starch, or a combination thereof.

In one or more embodiments, in step C), the starch comprises a non-modified or modified vegetable starch, rice starch, tapioca starch or a combination thereof; preferably wherein the starch comprises potato starch, waxy maize starch, tapioca starch, or a combination thereof.

In one or more embodiments, in step C), the starch is fed to the extruder barrel in the form of a dry powder.

In one or more embodiments, the process comprises feeding additives selected from:
flavouring additives;
colouring additives;
one or more of: i) polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate; ii) hydrocolloids; and iii) gums, preferably selected from xanthan gum, guar gum, locust bean gum, gellan gum, gum arabic, vegetable gum, tara gum, tragacanth gum, konjac gum, fenugreek gum, and gum karaya;
an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, salt, spices, fibre, flavour components, colourants, thickening and gelling agents, egg powder, enzymes, gluten, vitamins, preservatives, sweeteners, oxidising agents, reducing agents, anti-oxidants, and acidity regulators.

In one or more embodiments, the additives are in the form of a dry powder.

In one or more embodiments, the additives are fed in step A), between step A) and step B), in step B), between step B) and C), in step C), between step C) and D) or in step D).

In one or more embodiments, the amount of one or more of flavouring additives is from 0.5% to 2% by weight.

In one or more embodiments, the amount of one or more colouring additives is from 0.5% to 5% by weight.

In preferable embodiments, the plant-based food dough or plant-based food product is suitable for consumption by vegetarians and vegans. Accordingly, in preferable embodiments, no animal protein is fed in the process.

In preferable embodiments, no animal-derived ingredient, i.e. such as animal derived proteins or fats, is fed in the process.

In one or more embodiments, steps A), B) and C) are realized simultaneously so that the non-animal protein and the starch are mixed with the water so as to form a slurry before feeding to the extruder barrel and are followed by step D) and step E). Preferably, the melted fat composition is fed at the same location or at a location downstream of the feeding location of slurry. A location upstream of the feeding location of water means an earlier point in the process located before the feeding point of water. A location downstream of the feeding location of water means a later point in the process located after the feeding point of water. Advantageously, the melted fat composition is fed at a location downstream of the feeding location of slurry. In this embodiment, it is believed that the fibrosity of the plant based food dough or product is further improved.

In one or more embodiments, steps A) and C) are realized simultaneously after step B) so that the non-animal protein and the starch are mixed so as to form a mixture before feeding to the extruder barrel and are followed by step D) and step E). Preferably, the melted fat composition, and the mixture of non-animal protein and starch are independently from each other fed at the same location, at a location upstream or at a location downstream of the feeding location of water.

In a preferred embodiment, steps A) and C) are realized simultaneously so that the non-animal protein and the starch are mixed so as to form a mixture before feeding to the extruder barrel and are followed by step B), step D) and step E). Preferably, the melted fat composition, and the mixture of non-animal protein and starch are independently from each other fed at the same location, at a location upstream or at a location downstream of the feeding location of water. Advantageously, the mixture of non-animal protein and starch are fed at a location upstream of the feeding location of water and the melted fat composition is fed at a location downstream of the feeding location of water.

In one or more embodiments, steps A), C) and D) are realized simultaneously so that the non-animal protein, starch and the melted fat are mixed together so as to form a fat mixture before feeding to the extruder barrel and are followed by steps B) and E). Preferably, the fat mixture is fed at the same location, at a location upstream or at a location downstream of the feeding location of water. Advantageously, the fat mixture is fed at a location upstream of the feeding location of water.

In one or more embodiments, steps B) and D) are realized simultaneously after steps A) and C) so that water and the melted fat are mixed together so as to form an emulsion before feeding to the extruder barrel and are followed by step E).

In one or more embodiments, the extruder barrel is set at a temperature from 30 to 250° C., preferably from 30 to 200° C., more preferably from 30 to 180° C., such as from 30 to 165° C.

Typically, the extruder barrel comprises at least one screw. The speed of the screw or screws of the extruder may vary depending on the particular apparatus. For example, the extruder barrel comprises two screws rotating at a speed of from 100 to 500 rpm, preferably from 120 to 300 rpm.

The pressure within the extruder barrel is typically of from about 0.1 to 25 bars. The barrel pressure is dependent on numerous factors including, for example, the extruder screw speed, feed rate of the mixture to the barrel, feed rate of water to the barrel, and the viscosity of the ingredients within the barrel. One skilled in the art may adjust the pressure to achieve the desired properties.

In one or more embodiments, in step E), the plant-based food mixture obtained in step D) pass through a breaker plate before entering the cooling die. It is believed that the breaker plate improves the fibrosity of the plant-based dough.

In one or more embodiments, the cooling die is cooled using a chiller unit maintained at a temperature from 20 to 80° C., preferably from 30 to 70° C., more preferably from 35 to 55° C.

In one or more embodiments, the feeding rate in steps A) to D) is from 1 to 20 kg·h⁻¹, preferably from 1 to 10 kg·h⁻¹ and advantageously from 1 to 5 kg·h⁻¹.

In one or more embodiments, the process comprises a step F) of shaping the plant-based food dough into a plant-based food product.

In one or more embodiments, the shaping step F) is performed by cutting, moulding, pressing, rolling, grinding, dicing, marination, or any combination thereof.

In one or more embodiments, the process comprises a step G) of at least partially cooking the plant-based food dough into a plant-based food product.

In one or more embodiments, the cooking step G) comprises a baking step, a boiling step, a frying step, a steaming step and/or a microwaving step.

According to a second aspect of the invention, there is provided a plant-based food dough obtainable by the process according to the present invention, wherein the plant-based food dough has a chewiness from 3600 to 5000 g.

Preferably, the plant-based food dough has a hardness from 8000 to 11000 g.

According to a third aspect of the invention, there is provided a plant-based food product obtainable by the process according to the present invention.

The plant-based food product may be an uncooked food product, a cooked food product, or a partially cooked food product. For example, the plant-based food product is selected from a meat analogue composition, a cheese analogue composition or a seafood analogue composition.

In one or more embodiments, the food product is a vegetarian or vegan meat substitute food product. Preferably, the vegetarian or vegan meat substitute food product is a burger, sausage, meat ball, nugget, patty, mince product, breast, meatloaf, or other product intended to mimic conventional meat-based food products.

In one or more embodiments, the food product is a vegetarian or vegan cheese substitute food product. Preferably, the food product comprises a pizza cheese, a sandwich cheese, a feta cheese, a soft spreadable cheese, or a hard cheese; preferably wherein the food product comprises a pizza cheese, a sandwich cheese, or a feta cheese.

In one or more embodiments, the food product is a vegetarian or vegan seafood substitute food product. Preferably, the food product is a calamari analogue product, prawn analogue product, lobster analogue product, crab analogue product, crabstick analogue product, scampi analogue product and fish analogue product; preferably wherein the food product is a calamari analogue food product.

The properties of the food doughs or food products prepared using the melted fat composition may be measured by any suitable means. Properties of interest may include juiciness (and/or dryness), hardness, adhesiveness, springiness, cohesiveness, gumminess, chewiness and resilience. Such means include taste testers, which can provide feedback on properties of the composition or food product such as juiciness (or dryness), texture, chewiness and hardness. Typically, multiple testers will be asked to mark or comment one or more properties of the composition or food product. If multiple testers are asked, an average of the results can be taken to observe the general impression of the food product.

Properties of the composition or food product may also be measured using specialised equipment. For example, texture profile analysis (TPA) is a technique used to characterize textural attributes of solid and semisolid materials and may be used to determine the hardness, adhesiveness, springiness, cohesiveness, gumminess, chewiness and resilience. Gumminess is defined as the product of hardness×cohesiveness. Chewiness is defined as the product of gumminess×springiness (hardness×cohesiveness×springiness). In this technique, the test material may be compressed two times in a reciprocating motion, mimicking the chewing movement in the mouth, producing a Force versus Time (and/or distance) graph, from which the above information can be obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

The Force versus Time (and/or distance) graph typically includes two peaks in force, corresponding to the two compressions, separated by a trough. Force may be measured in gravitational force equivalent (g-force, g) or Newtons (N).

Hardness (g or N) is defined as the maximum peak force experienced during the first compression cycle.

Adhesiveness is defined as the negative force area for the first bite, i.e. the area of the graph between the two peaks in force which is at or below a force of 0 g or N. This represents the work required to overcome the attractive forces between the surface of a food and the surface of other materials with which the food comes into contact, i.e. the total force necessary to pull the compression plunger away from the sample. For materials with a high adhesiveness and low cohesiveness, when tested, part of the sample is likely to adhere to the probe on the upward stroke. Lifting of the sample from the base of the testing platform should, if possible, be avoided as the weight of the sample on the probe would become part of the adhesiveness value. In certain cases, gluing of the sample to the base of a disposable platform has been advised but is not applicable for all samples.

Springiness, also known as elasticity, is related to the height that the food recovers during the time that elapses between the end of a first compression and the start of a second compression. During the first compression, the time from the beginning of the compression at force=0 g or N to the first peak in force is measured (referred to as ‘Cycle 1 Duration’). During the second cycle, the time from the beginning of the second compression at force=0 g or N to the second peak in force is measured (referred to as ‘Cycle 2 Duration’).

Springiness is calculated as the ratio of these values, i.e. ‘Cycle 2 Duration’/‘Cycle 1 Duration’.

Cohesiveness is defined as the ratio of the positive force area, i.e. the area under the curve above a force of 0 g or N, during the second compression to that during the first compression. Cohesiveness may be measured as the rate at which the material disintegrates under mechanical action. Tensile strength is a manifestation of cohesiveness. If adhesiveness is low compared with cohesiveness then the probe is likely to remain clean as the product has the ability to hold together. Cohesiveness is usually tested in terms of the secondary parameters brittleness, chewiness and gumminess. Gumminess is defined as the product of hardness×cohesiveness and is a characteristic of semisolid foods with a low degree of hardness and a high degree of cohesiveness. Chewiness is defined as the product of gumminess×springiness (which equals hardness×cohesiveness×springiness) and is therefore influenced by the change of any one of these parameters.

Resilience is a measurement of how the sample recovers from deformation both in terms of speed and forces derived. It is taken as the ratio of areas from the first probe reversal point, i.e. the point of maximum force, to the crossing of the x-axis, i.e. at 0 g or N, and the area produced from the first compression cycle between the start of compression and the point of maximum force. In order to obtain a meaningful value of this parameter, a relatively slow test speed should be selected that allows the sample to recover, if the sample possesses this property.

According to a fourth aspect of the invention, there is provided the use of a fat composition in a plant-based food dough or a plant-based food product, wherein the plant-based dough or plant-based food product is obtainable by a process according to the first aspect of the invention; wherein the fat composition is as described above in accordance with the first aspect of the invention; and wherein the use comprises using the fat composition to (i) improve the hardness of the plant-based food product or plant-based dough when compared to an analogous food product or plant-based dough comprising the same amount by weight of liquid oil, or a food product or plant-based dough that does not comprise any fat or oil; (ii) improve the chewiness of the plant-based food product or plant-based dough when compared to an analogous food product or plant-based dough comprising the same amount by weight of liquid oil, or a food product or plant-based dough that does not comprise any fat or oil; (iii) improve the fibrosity of the plant-based food product or plant-based dough when compared to an analogous food product or plant-based dough comprising the same amount by weight of liquid oil; or (iv) improve the mouthfeel of the plant-based food product or plant-based dough when compared to an analogous food product or plant-based dough comprising the same amount by weight of liquid oil, or a food product or plant-based dough that does not comprise any fat or oil.

Preferably, the use comprises carrying out a process according to a first aspect of the invention with the fat composition.

Improved hardness of the plant-based food dough or a plant-based food product comprising the melted fat composition is believed to make the plant-based food dough more closely resemble the texture of animal products.

The inventors have also found that the chewiness of the plant-based food dough or a plant-based food product increases when using the melted fat composition since liquid oil has a tendency to reduce the chewiness by being homogenously mixed with the other ingredients and the absence of oil may on the contrary increase too much the chewiness.

Additionally, without willing to be bound by any theory, it is believed that the melted fat composition collaborates with the other ingredients during mixing so as to obtain a fibrous structure that mimic the fibrosity of animal products.

Improved mouthfeel of the plant-based food dough or a plant-based food product comprising the melted fat composition is also believed to make the plant-based food dough more closely resemble the mouthfeel, juiciness and succulence of animal products.

### DESCRIPTION OF THE DRAWINGS

FIG. 1 depicts the hardness of a food dough prepared according to the process of the invention and also of several reference food doughs.

FIG. 2 depicts the chewiness of a food dough prepared according to the process of the invention and also of several reference food doughs.

FIG. 3 depicts photographs of a food dough prepared according to the process of the invention and also of several reference food doughs.

FIG. 4 shows the results of a panel preference test for food doughs prepared according to the process of the invention compared with several reference food doughs.

FIGS. 5 and 6 show the results of a panel juiciness test for a food dough prepared according to the process of the invention and also of several reference food doughs.

### DETAILED DESCRIPTION OF THE INVENTION

The following examples are for illustrative purposes only and are not intended to limit the scope of the invention in any way.

### Example 1

Comparative rapeseed oil was used.

Fat A was prepared by chemical interesterification of a blend of 70 wt % shea butter and 30 wt % coconut oil.

Various properties of Fat A are shown in Table 1 below and contrasted against comparative fat rapeseed oil.

TABLE 1

| | |
|---|---|
| Comparative fat | |
| rapeseed oil | Fat A |

Fatty acid residue concentrations (wt %)

| | | |
|---|---|---|
| C4:0 | — | 0.0 |
| C6:0 | 0.0 | 0.2 |
| C8:0 | 0.0 | 2.4 |
| C10:0 | 0.0 | 1.8 |
| C12:0 | 0.0 | 14.3 |
| C14:0 | 0.0 | 5.4 |
| C16:0 | 4.5 | 4.6 |
| C16:1c | 0.2 | 0.0 |
| C16:1tr | 0.0 | 0.0 |
| C17:0 | 0.0 | 0.0 |
| C18:0 | 1.5 | 32.9 |
| C18:1c | 60.5 | 32.4 |
| C18:1tr | 0.0 | 0.0 |
| C18:2c | 19.6 | 4.7 |
| C18:2tr | 0.0 | 0.0 |
| C18:3c | 9.3 | 0.1 |
| C18:3tr | 0.2 | 0.0 |
| C20:0 | 0.6 | 1.0 |
| C20:1c | 1.6 | 0.1 |
| C22:0 | 0.3 | 0.0 |
| C22:1c | 0.8 | 0.0 |
| Unknown | 0.4 | 0.0 |
| SAFA | 7.1 | 62.7 |
| Carbon Number | | |
| 26 | — | 0.0 |
| 28 | — | 0.0 |
| 30 | — | 0.0 |
| 32 | — | 0.2 |
| 34 | — | 0.4 |
| 36 | — | 0.7 |
| 38 | — | 2.0 |
| 40 | — | 2.1 |
| 42 | — | 5.5 |
| 44 | — | 7.4 |
| 46 | — | 5.8 |
| 48 | — | 22.6 |
| 50 | — | 9.3 |
| 52 | — | 7.2 |
| 54 | — | 35.4 |
| 56 | — | 1.7 |
| CN46 + 48 | — | 28.4 |
| St2M | — | 6.4 |
| SFC10° C. | 0 | 54 |
| SFC20° C. | 0 | 28 |
| SFC30° C. | 0 | 9 |
| SFC35° C. | 0 | 4 |
| SFC40° C. | 0 | 1.5 |

It can be seen that Fat A has a higher solid fat content at lower temperatures 10° C. and 20° C. and at mouth-like temperatures of from 30° C. to 35° C. than rapeseed oil. This is believed to contribute to the texture of the plant-based food dough and plant-based food product when consumed. It can also be seen that Fat A has a reasonable saturated fatty acid residue content. This is believed to improve to the nutritional value of the melted fat composition. Fat A also contains a great content of C46 and C48 triglycerides, and also St2M triglycerides. The latter are fast crystallising triglycerides, which contribute towards the structure building properties of the fat composition.

### General Method for Preparation of Plant-Based Chicken Chunks

Plant-based chicken chunks were made from melted Fat A (i.e. according to the invention), from liquid rapeseed oil and without any fat or oil.

The following procedure was used for the preparation of the plant-based chicken chunks using an extruder of the following examples:
1. Extrusion was performed in a Coperion Type ZSK 26 twin-screw extruder with a screw diameter of 2,6 cm and a length-to-diameter ratio of 25:1. The extruder comprised six extruder barrel segments 1 to 6, to which a rectangular cooling die with the dimensions 4.0×0.5×62.0 cm (width×height×length) was connected. Soy protein concentrate in dry form was fed to the first barrel segment of the extruder by a gravimetrically controlled feeder,
2. Water was pumped into the second barrel segment; the barrel segments 2,3,4,5 and 6 of the extruder barrel were following a temperature profile of 30, 60, 90, 120, 155° C. and the extruder barrel comprised two screws rotating at a speed of 250 rpm,
3. optionally, the extruder barrel was fed with the melted fat or the liquid oil in the fourth barrel segment so as to form a plant-based food mixture.
4. The soy concentrate and the melted fat were dosed so that the feed rate of protein and oil/melted fat together was 3.8 kg·h⁻¹;
5. The water was dosed so the total feed rate was between 11.4 and 11.5 kg·h⁻¹;
6. the plant-based food mixture was extruded through the cooling die cooled by a chiller unit being at a temperature of 40° C. so as to form a plant-based food dough; the plant based food dough was cut into 10-15 cm strips, vacuum packed and stored at about −19° C.;
7. the plant-based dough was wrapped in aluminium foils and baked in an oven at 160° C. during 10 min so as to obtain plant-based chicken chunks.

The compositions of the chicken chunks of Comparative Example 1, Example 2, Comparative Example 3, Example 4 and Comparative Example 5 are prepared according to the above method and are shown below in Table 2.

TABLE 2

| | Comparative | | Comparative | | Comparative |
|---|---|---|---|---|---|
| Ingredients | Example 1 | Example 2 | Example 3 | Example 4 | Example 5 |
| water (wt. %) | 67 | 67 | 67 | 67 | 67 |
| Soy protein | 31 | 31 | 29 | 29 | 33 |
| concentrate (wt. %) | | | | | |
| Rapeseed oil | 2 | 0 | 4.5 | 0 | 0 |
| liquid (wt. %) | | | | | |
| Fat A (melted) (g) | 0 | 2 | 0 | 4.5 | 0 |

### Assessment of Chicken Chunks Properties before Baking (i.e of Plant-Based Food Dough)

Texture profile analysis (TPA) was used to determine the hardness, defined as the maximum peak force during the first compression cycle (first bite) which has often been substituted by the term firmness, and the chewiness, defined as the product of gumminess×springiness (hardness×cohesiveness×springiness). TPA was performed on a TA.XT₂ machine (by Stable Micro Systems) fitted with a 30 kg load cell and a 50 mm diameter plastic probe. The machine was programmed to run with the following settings: pre-test speed: 1 mm/s; test speed: 1 mm/s; post-test speed: 1 mm/s; compression depth: 4 mm; time between cycles: 5 s; trigger type: automatic on 0.49 N; data acquisition rate: 200 pps. The test material was thawed air-tight at 5° C., tempered air-tight in a cabinet of 20° C. and from the middle of the sample strips squared pieces of 2 cm×2 cm were cut out before analysis. Two samples were placed on top of each other for measurement so the height of the measured sample was 0.8-1 cm. The test material was compressed two times in a reciprocating motion, mimicking the chewing movement in the mouth. A Force versus Time (and/or distance) graph was obtained, from which the desired information was obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein. The results given in Table 3 are based on the average of 12 measurements.

TABLE 3

| Property Before | Comparative | | Comparative | | Comparative |
|---|---|---|---|---|---|
| Cooking | Example 1 | Example 2 | Example 3 | Example 4 | example 5 |
| Hardness (g) | 7684 | 10321 | 6391 | 8750 | 11225 |
| Chewiness (g) | 3522 | 5048 | 2750 | 3872 | 5486 |

Examples 2 and 4 according to the invention and Comparative Example 5 have hardness values correlating with good processability, typically needed to enable proper forming of the chicken chunks and to get the adequate texture of the chicken chunks. Comparative Examples 1 and 3 (based on rapeseed liquid oil) result in lower hardness values. Comparative example 3 is barely acceptable since its hardness is barely sufficient for being further processed into meat analogue products as well as its texture is too soft for mimicking the firmness of chicken chunks for consumption. Examples 2 and 4 according to the invention have chewiness values that give a good texture for consumption. These values are better than the value of Comparative Example 5, which shows a too high chewiness value correlated with a rubbery texture at consumption, and the value of Comparative Examples 3, which shows a too low chewiness value correlated with an insufficient texture at consumption. Example 4 shows slightly higher hardness and chewiness values than comparative example 1, in which half of the amount of oil is used. As a conclusion, Fat A could be used to increase the amount of added fat in the meat analogue, whilst maintaining some and improving other desirable sensory and performance characteristics of the meat analogue.

### Properties of the Chicken Chunks of the Examples after Baking (i.e of Plant-Based Food Products)

A sensory evaluation was performed on Comparative Example 1, Example 2, Comparative Example 3, Example 4 and Comparative Example 5. Multiple testers were asked to evaluate one or more properties of the composition or food product, such as fibrosity, juiciness/dryness and chewiness. The tasters were instructed to bend the strips for tasting so that they had a thickness of 0.8-1 cm.

Comparative Example 1 and Example 2 were compared sensorially. Example 2 (including Fat A) had a moist appearance and was described as slightly harder and less dry than Comparative Example 1 (including rapeseed oil).

Comparative example 3 and Example 4 according to the invention were compared sensorially. Comparative example 3 (including rapeseed oil) was described as dryer, softer, starchier, less chewy and less fibrous than Example 4 (including Fat A). Furthermore, the tasters noted that Example 4 had a moist appearance which added to a juicy impression. In addition, Comparative example 3 broke more easily than Example 4, when bended. This is correlating with the lower fibrosity observed in Comparative Example 3. Example 4 was preferred over Comparative Example 3.

In a comparison of Example 2 and Comparative example 5, Example 2 (including Fat A) was described as softer, less adhesive and less dense than Comparative example 5 (no fat/oil included) and having a similar fibrosity as Comparative example 5. Example 2 was preferred over Comparative Example 5.

### Example 2

Two plant-based food doughs were prepared. Each dough contained 35% by weight of soy protein concentrate; 63% water and 2% fat. The soy protein concentrate contained 66.7% protein so that the total protein content by weight of each food dough was 23.3%. A negative control plant-based food dough was also prepared that did not contain any fat or oil. This dough contained 65% water and 35% of the same soy protein concentrate.

The fat in the first food dough was the same fat used in Example 1 (Fat A). The fat in the second food dough was rapeseed oil.

The three plant-based doughs were extruded in accordance with a process of the present invention. The screw speed of the extruder was 300 rpm. The dosing settings of the extruder for each food dough are as shown below.

$$Negative control : Water = 1300 ml / hour ; protein = 0.7 kg / hour .$$

$$Each fat - containing food dough : Water = 1260 ml / hour ; protein 0.7 kg / hour ; fat = 40 ml / hour = 60 ° C .$$

The extruder used was a Process 16 extruder from Thermofisher which is a double-screw pilot-scale extruder. The protein is first fed into a gravimetric twin-screw feeder. Water is then fed through a port by a peristaltic pump. Fat or oil is then fed through a second port by a heated peristaltic pump. All of these materials then move through the extruder towards a cooling die.

The samples of plant-based dough were then cooked in an oven at 160° C. for 15 minutes before being analysed at 60° C. for hardness and chewiness.

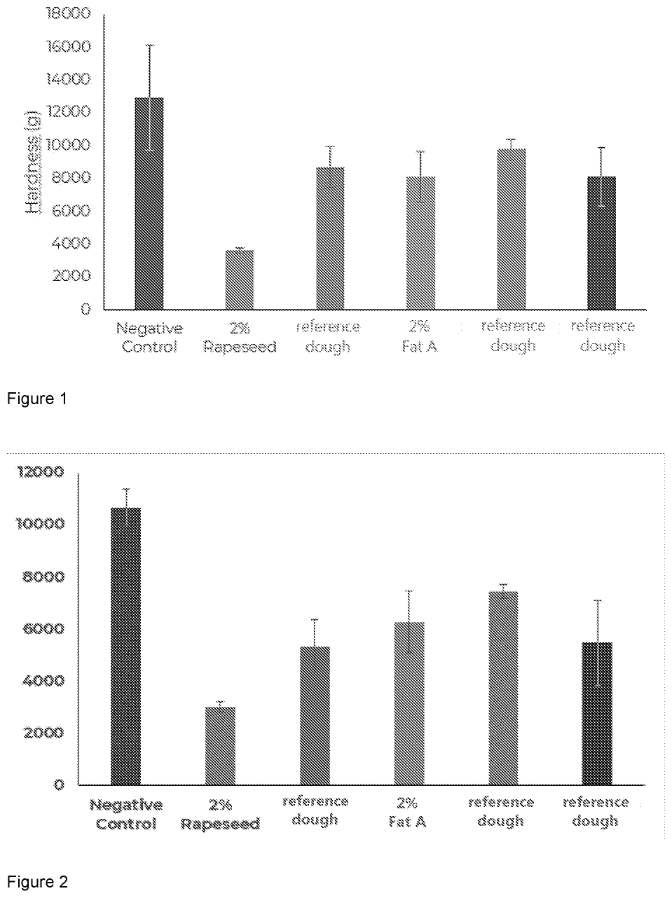

The results of the experiments are shown in FIGS. 1 and 2. The hardness and chewiness of certain reference food doughs is also shown. The food dough containing Fat A had a desirable hardness and chewiness that was greater than that of rapeseed oil. The food doughs made from rapeseed oil were too soft to effectively resemble the harder texture and chewiness of meat or cheese. The experiment thus shows that using the process of the invention where a melted fat is used (i.e. a fat in the melted state that has a melting point of above 20° C.), the resultant food dough has desirable sensory properties when compared to extruded food doughs that comprise a room temperature liquid oil such as rapeseed oil. The food dough that did not contain any fat was extremely chewy and hard which is associated with unpleasant sensory properties of the food dough.

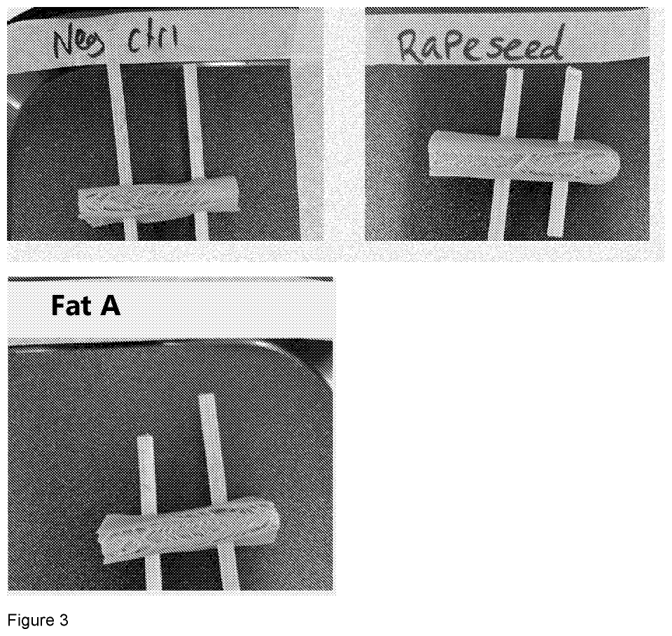

The three extruded food doughs were also analysed for their fibrosity. Photographs of the three doughs are shown in FIG. 3. The food dough produced using the process of the invention with Fat A was found to have a more pronounced fibrosity than the other two food doughs. This feature of the extrudates is beneficial for the food dough in effectively mimicking the fibrous nature of meat and certain types of cheese.

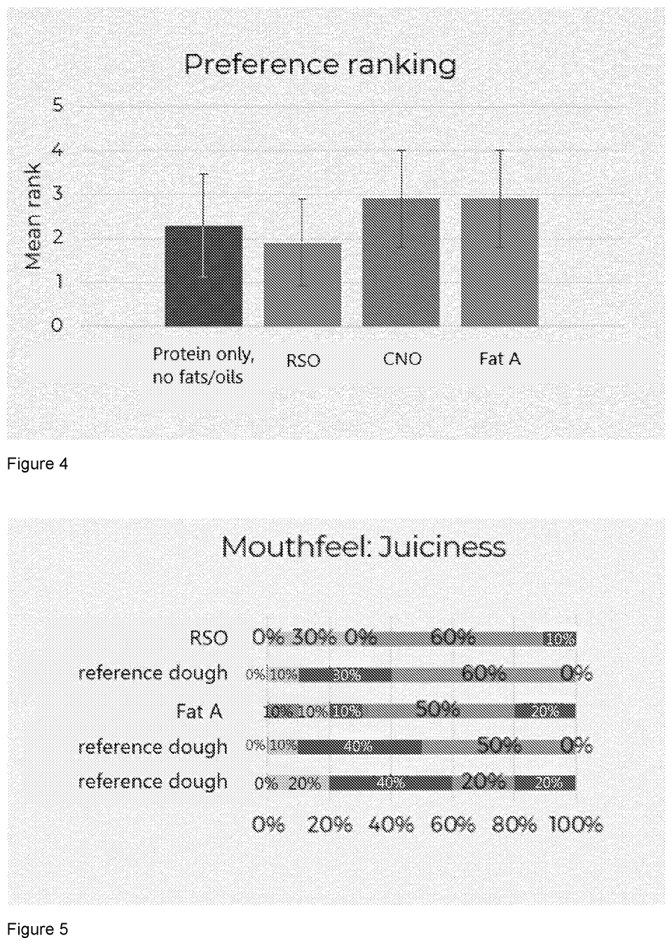

The three food doughs were then consumed by a panel of sensory experts who ranked each dough by preference. A further fourth food dough produced in the same way but comprising 2% by weight of coconut oil was also consumed and included in the rankings. Coconut oil also has a melting point of above 20° C. The results of the experiment are shown in FIG. 4. As can be seen in FIG. 4, the doughs comprising Fat A and coconut oil had preferable organoleptic properties to the dough comprising rapeseed oil and the control dough that did not contain fat.

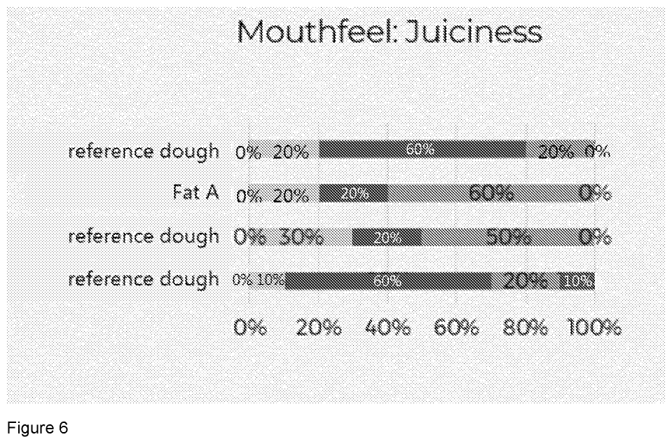

The doughs comprising Fat A and rapeseed oil along with several reference doughs were then assessed by the panel for juiciness relative to the dough comprising no fat, and then relative to the dough comprising rapeseed oil. The results relative to the fat free dough are shown in FIG. 5 where it can be seen that all doughs were considered by the panel to be juicier than the dough comprising no fat. The results relative to rapeseed oil are shown in FIG. 6 where it can be seen that the dough containing Fat A was considered juicier than the dough containing rapeseed oil.

1. A process for preparing a plant-based food dough using an extruder, said extruder comprising an extruder barrel and a cooling die, the process comprising the steps of:
A). feeding the extruder barrel with less than 35 wt % by weight of non-animal protein relative to the total weight of the plant-based food dough;
B). feeding the extruder barrel with from 35 to 80 wt % by weight of water relative to the total weight of the plant-based food dough;
C). feeding the extruder barrel with less than 45% by weight of a starch relative to the total weight of the plant-based food dough;
D). feeding the extruder barrel with from 1 to 30 wt % by weight of a melted fat composition relative to the total weight of the plant-based food dough so as to form a plant-based food mixture;
E). extruding the plant-based food mixture obtained in step D) through the cooling die so as to form a plant-based food dough.

2. The process according to claim 1, wherein, in step D), the amount of the melted fat composition is from 1% to 15% by weight relative to the total weight of the plant-based food dough or the amount of the melted fat composition is from 15 to 30% by weight relative to the total weight of the plant-based food dough.

3. (canceled)

4. The process according to claim 1, wherein, in step D), the melted fat composition comprises from 20% to 85% by weight of saturated fatty acid residues; from 2% to 50% by weight of stearic acid residues (C18:0); and from 1% to 35% by weight of lauric acid residues (C12:0); wherein said percentages of fatty acid residues refers to fatty acids bound as acyl groups in glycerides in the fat composition and being based on the total weight of C4 to C24 fatty acid residues bound as acyl groups present in the fat composition.

5. (canceled)

6. The process according to claim 1, wherein, in step D), the melted fat composition is a non-hydrogenated fat composition.

7. The process according to claim 1, wherein, in step D), the melted fat composition comprises 35% by weight or less of palmitic acid (C16:0).

8. The process according to claim 1, wherein, in step D), the melted fat composition has a weight ratio of stearic acid (C18:0) to palmitic acid (C16:0) of from 1:1 to 12:1 or from 1:1 to 1:10.

9. (canceled)

10. The process according to claim 1, wherein, in step D), the melted fat composition has a weight ratio of lauric acid (C12:0) to stearic acid (C18:0) of from 1:4 to 4:1 or from 4:1 to 8:1.

11-13. (canceled)

14. The process according to claim 1, wherein, in step D), the melted fat composition comprises less than 25% of myristic acid (C14:0) or the composition does not comprise myristic acid.

15. The process according to claim 1, wherein, in step D), the melted fat composition comprises at least one fat selected from shea butter, shea stearin, shea olein, cocoa butter, cocoa stearin, cocoa olein, allanblackia fat, kokum fat, mango kernel fat, sal fat, illipe butter, coconut oil, coconut oil stearin, coconut oil olein, palm kernel oil, palm kernel olein, palm olein, rapeseed oil, palm oil, palm kernel stearin, babassu oil, any fraction thereof and any mixture thereof.

16-17. (canceled)

18. The process according to claim 1, wherein in step D), the melted fat composition comprises an interesterified fat.

19-20. (canceled)

21. The process according to claim 1, wherein, in step D), the melted fat composition comprises an interesterified blend of from 20% to 80% by weight of shea butter and from 20% to 80% by weight of coconut oil and/or the melted fat composition comprises an interesterified blend of from 20% to 80% by weight of shea stearin and from 20% to 80% by weight of coconut oil.

22. (canceled)

23. The process according to claim 1, wherein, in step D), the melted fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of sunflower oil and/or the melted fat composition comprises a blend of (i) from 20% to 80% by weight of an interesterified blend of from 20% to 80% by weight of shea butter and/or shea stearin and from 20% to 80% by weight of coconut oil; and (ii) from 20% to 80% by weight of rapeseed oil.

24. (canceled)

25. The process according to claim 1, wherein, in step D), the melted fat composition comprises less than 10% by weight of palm oil.

26. The process according to claim 1, wherein, in step D), the melted fat composition comprises an interesterified blend of palm olein and palm kernel oil.

27. The process according to claim 1, wherein, in step D), the melted fat composition comprises an interesterified blend of from 25% to 75% by weight of palm olein and from 25% to 75% by weight of palm kernel oil.

28. The process according to claim 1, wherein, in step D), the melted fat composition comprises a blend of interesterified palm olein IV 56 and palm olein IV 62-64.

29. The process according to claim 1, wherein, in step D), the melted fat composition comprises a blend of from 20% to 80% by weight of interesterified palm olein IV 56 and from 20% to 80% by weight of palm olein IV 62-64.

30. The process according to claim 1, wherein, in step D), the melted fat composition has a melting temperature above 20° C.

31. The process according to claim 1, wherein, in step D),
i). the melted fat composition has a solid fat content (SFC) N40 of less than 10, measured on unstabilised fat according to ISO 8292-1;
ii). the melted fat composition has a solid fat content (SFC) N20 of from 35 to 60, as measured on the unstabilised fat according to ISO 8292-1; or the melted fat composition has a solid fat content (SFC) N20 of from 2 to 25, as measured on the unstabilised fat according to ISO 8292-1; and/or
iii). the melted fat composition has a solid fat content (SFC) N30 of from less than 36, as measured on the unstabilised fat according to ISO 8292-1.

32. The process according to claim 1, wherein the melted fat composition has a solid fat content (SFC) N35 of less than 5, measured on unstabilised fat according to ISO 8292-1.

33. The process according to claim 1, wherein, in step D), the melted fat composition comprises from 5 to 35 percent by weight of CN46 and CN48 triglycerides.

34. The process according to claim 1, wherein, in step D), the melted fat composition comprises from 2 to 12 percent by weight of St2M triglycerides.

35. The process according to claim 1, wherein, prior to step D), a fat composition is heated so as to melt and form the melted fat composition in a melted state.

36. The process according to claim 1, wherein, in step A), the amount of non-animal protein is from 0 to 15% or from 15 to 35% by weight relative to the total weight of the plant-based food dough.

37-40. (canceled)

41. The process according to claim 1, wherein, in step B), the amount of water is from 40 to 80 wt % by weight relative to the total weight of the plant-based food dough.

42. (canceled)

43. The process according to claim 1, wherein, in step C), the amount of starch is from 0% to 45% by weight of a starch relative to the total weight of the plant-based food dough.

44-51. (canceled)

52. The process according to claim 1, wherein no animal protein is fed in the process.

53. The process according to claim 1, wherein no animal-derived ingredient is fed in the process.

54. The process according to claim 1, wherein steps A), B) and C) are realized simultaneously so that the non-animal protein and the starch are mixed with the water so as to form a slurry before feeding to the extruder barrel and are followed by step D) and step E).

55. (canceled)

56. The process according to claim 1, wherein steps A) and C) are realized simultaneously after step B) so that the non-animal protein and the starch are mixed so as to form a mixture before feeding to the extruder barrel and are followed by step D) and step E).

57. The process according to claim 1, wherein steps A) and C) are realized simultaneously so that the non-animal protein and the starch are mixed so as to form a mixture before feeding to the extruder barrel and are followed by step B), step D) and step E).

58. (canceled)

59. The process according to claim 1, wherein steps A), C) and D) are realized simultaneously so that the non-animal protein, starch and the melted fat are mixed together so as to form a fat mixture before feeding to the extruder barrel and are followed by steps B) and E).

60. (canceled)

61. The process according to claim 1, wherein steps B) and D) are realized simultaneously after steps A) and C) so that water and the melted fat are mixed together so as to form an emulsion before feeding to the extruder barrel and are followed by step E).

62-64. (canceled)

65. The process according to claim 1, wherein the process comprises a step F) of shaping the plant-based food dough into a plant-based food product.

66. (canceled)

67. The process according to claim 1, wherein the process comprises a step G) of at least partially cooking the plant-based food dough into a plant-based food product.

68. (canceled)

69. A plant-based food dough obtainable by a process according to claim 1, wherein the plant-based food dough has a chewiness from 3600 to 5000 g.

70-81. (canceled)
